(19) United States
(12) Patent Application Publication
(10) Pub. No.: US 2009/0280048 A1
(43) Pub. Date: Nov. 12, 2009

(54) PRODUCTION OF PYROGENIC METAL OXIDES IN TEMPERATURE-CONTROLLED REACTION CHAMBERS

(75) Inventors: Torsten Gottschalk-Gaudig, Mehring (DE); Markus Niemetz, St. Radegund (AT)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/305,115

(22) PCT Filed: Jul. 31, 2006
(86) PCT No.: PCT/EP2006/064851

§ 371 Date: Dec. 16, 2008

(30) Foreign Application Priority Data
Jun. 29, 2006 (DE) 10 2006 030 002.5

(51) Int. Cl. C01B 33/12; B01J 19/00

(52) U.S. Cl. 423/336; 422/198

(57) ABSTRACT

Pyrogenic metal oxides having consistent quality and consistency between batches are prepared by flame hydrolysis in a reactor whose walls are cooled to below 500° C.

The invention relates to pyrogenic metal oxides with excellent and consistent quality, to their preparation, and to their use. Pyrogenic metal oxides, more particularly fumed silicas, find broad industrial use as reinforcing fillers in elastomers, as rheological additives for coating materials, adhesives, and sealants, or in the chemical-mechanical polishing of surfaces, in the semiconductor sector, for example.

Pyrogenic metal oxides such as, for example, fumed silica are obtained by high-temperature hydrolysis of halogen silicon compounds in an oxygen-hydrogen flame, as described for example in Ullmann's Encyclopedia of Industrial Chemistry (Wiley-VCH Verlag GmbH & Co. KGaA, 2002). Quality features of pyrogenic metal oxides that are relevant for the application sectors identified above are their specific surface area, the three-dimensional structure of the sintered aggregates, the average hydrodynamic equivalent diameter of the sintered aggregates, the fraction of coarse particles, and the concentration of metallic and nonmetallic impurities. These quality features are influenced exclusively or at least predominantly in the reaction zone of the operation, i.e., in the flame zone.

Furthermore, consistent compliance with the quality features identified above is critical for the use of the metal oxide particles in the stated fields of application. An inherent characteristic of the production of pyrogenic particulate solids is the fact that an improvement in quality post synthesis, by means of purification steps such as reprecipitation or recrystallization, for example, is not possible.

High product quality in this context means that the improved production conditions reduce the fraction of coarse articles, which is manifested in a narrower distribution of the hydrodynamic equivalent diameter of the sintered aggregates, relative to products obtained without the use of the inventively improved production conditions.

Consistent product quality means that, in a statistical evaluation of the quality features, the resulting standard distribution of the measured values exhibits a narrow standard deviation.

It is an object of the invention to improve on the prior art, more particularly to provide pyrogenic metal oxide particles of consistently high quality and to find production conditions which on the industrial scale lead to consistent product, quality on the part of the pyrogenic metal oxides.

Surprisingly, and in no way foreseeably for the skilled worker, it has now been found that by controlling the flame reactor wall temperature it is possible to significantly enhance the quality and consistency of quality of the resulting pyrogenic metal oxides.

The invention provides a metal oxide production apparatus characterized in that it has at least one burner nozzle, a feed apparatus for the reaction materials, and a reactor-wall cooling system which can be set to a wall temperature of less than 500° C., preferably less than 250° C., and more preferably to less than 200° C.

The invention further provides a process for producing pyrogenic metal oxides, characterized in that a high-temperature hydrolysis of vaporizable halogen metal compounds of the general formula I

MHₐR_{b}X_{c} (I)

to metal oxides in the general formula II

M_{d}Oₑ (II)

takes place, with the following possible definitions:
M: Si, Al, Ti, Zr, Zn, Ce, Hf, Fe
R: an M-C-bonded, C₁-C₁₅ hydrocarbon radical, preferably a C₁-C₈ hydrocarbon radical and more preferably a C₁-C₃ hydrocarbon radical, or aryl radical, it being possible for each R to be alike or different,
X: halogen atom, OR radical, R being as defined above,
a: 0, 1, 2, 3,
b: 0, 1, 2, 3,
c: 1, 2, 3, 4,
d: 1, 2,
e: 1, 2, 3
   with the proviso that the sum a+b+c is

### 4 for Si, Ti, Zn, Zr, Hf,

### 3 for Al, Fe,

### 2 for Zn,

the process taking place at a wall temperature of less than 500° C. and more preferably less than 200° C.

The metal halogen compounds of the general formula I that are brought to reaction in accordance with the invention are characterized in particular by the fact that they are vaporizable without decomposition at temperatures of less than 200° C., preferably less than 100° C., and more preferably less than 80° C.

Metal halogen compounds of the general formula I that are used with preference are tetrachlorosilane, methyltrichlorosilane, hydrogentrichlorosilane, hydrogenmethyldichlorosilane, tetramethoxysilane, tetraethoxysilane, hexamethyldisiloxane, or mixtures thereof. Tetrachlorosilane is particularly preferred. The metal halogen compounds of the general formula I can be brought to reaction in the form of the pure compound or as a mixture of different compounds of the general formula I, it being possible for the mixture to be produced in the vaporizer unit prior to introduction, or to be formed in the vaporizer by a parallel introduction of the different components. Preference is given to mixing upstream of the vaporizer.

The metal halogen compounds may further comprise preferably nonmetal compounds such as hydrocarbons in a mass fraction of up to 20%.

Able to serve as combustion gases for obtaining the requisite temperatures and as a source of water are, preferably, H₂, O₂, air, oxygen-enriched air, CO, and hydrocarbons such as methane, ethane, and propane. Preference is given to hydrogen, air, and methane.

The water needed for the hydrolysis of the chlorosilanes is preferably generated by reaction of the combustion gases. In other words, preferably no steam is fed into the flame reactor.

The feeding of the combustion gases and of the vaporized metal halogen compounds of the general formula I takes place by means of nozzles of known construction into the flame reactor space.

The reaction between the stated combustion gases is highly exothermic, with ΔH²⁹⁸=−12 kJ/mol. The reaction gases are cooled downstream of the reactor via heat exchanger systems in accordance with the prior art.

The flame reactor is composed of aluminum or of heat-resistant and corrosion-resistant steel, preferably special-purpose steel with a predominant nickel fraction.

The reactor in question is preferably a closed flame reactor as described in DE 1244125, for example.

The wall area of the flame reactor is less than 200 m², preferably less than 100 m². The flame reactor walls may possess any desired closed geometric form, preference being given to a cylindrical design.

The walls of the flame reactor are preferably cooled. The jacket of the flame reactor may be of single-wall or double-wall design, preference being given to the double-wall design.

The cooling medium flows through the region between the two walls, the distance preferably being chosen such as to result in laminar or turbulent flow, depending on the cooling medium employed. Turbulent flow is preferred.

With preference it is also possible to cool the jacket via a tube coil which is wound around the flame reactor walls through which the cooling medium flows. Any desired combinations of both variants are also possible. The cooling geometry is designed such that the flow and the heat transfer coefficient of the cooling medium are configured optimally, as a function of the cooling medium.

Cooling is accomplished by passing the cooling medium over the outer face of the flame reactor. The inside walls of the flame reactor are cooled via the wall surface, and the cooling medium is heated.

The cooling medium is a suitable substance or mixture of substances with an appropriate heat transfer coefficient, preferably water or cooling brine, or a gaseous substance, preferably air.

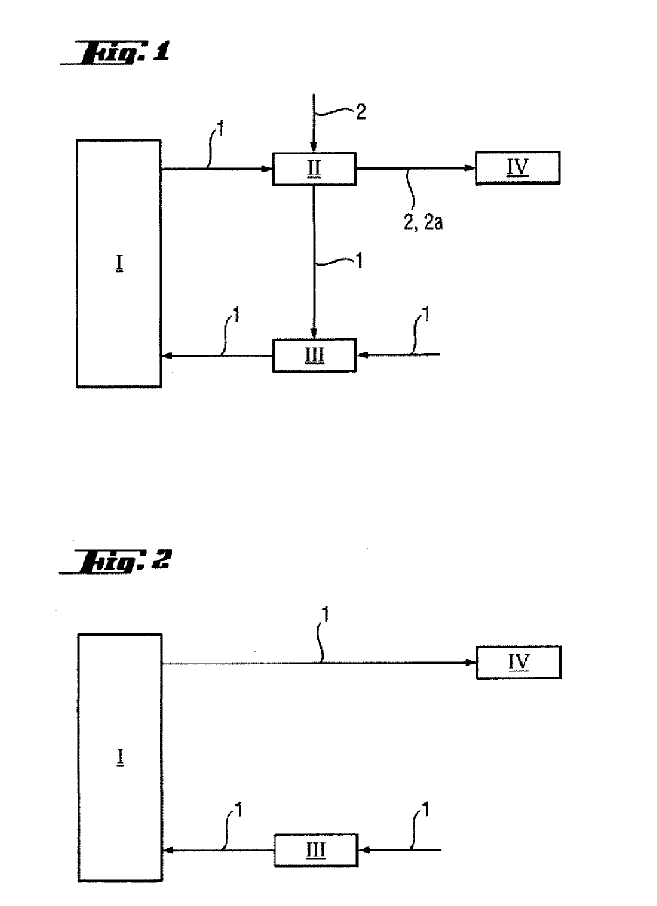

The cooling medium can preferably be circulated (FIG. 1) or else delivered directly to consumer units (FIG. 2). To this end the cooling medium (1) is circulated actively with conveying assistants (III), preferably one or more pumps of suitable construction, or is passed over the outer face of the flame reactor (I) by the autogenous pressure or by convection, particularly in the case of gaseous media. In the case of the circulation variant, the heated cooling medium is supplied to an exchanger element (II), where heat exchange with another medium (e.g. water, air) (2) can take place in order to cool the cooling medium down again. Where conveying assistants are used, the sequence of exchanger element (II) and conveying assistants (III) in the circuit can be switched arbitrarily and freely.

Where water is used as the cooling medium (1), it is preferred to recover the heat removed in the form of steam (2a). For this purpose the system is held under pressure. The higher the pressure of the system, the higher the temperature of the steam delivered. The internal pressure of the system is greater than 1 bar, preferably greater than 2 bar, and more preferably greater than 5 bar.

The steam generated in accordance with the invention can be utilized by means of known methods for heat generation or for the generation of electrical energy (IV).

In addition to the wall area itself, the same design can also be used to cool all of the internals as well, such as nozzles, probes, or process control equipment such as temperature meters or flame monitors, for example. This improves their service life significantly, and the impurities in the product as a result of corrosion of the internals are eliminated.

The internals can be cooled by way of the same cooling section, although it is also possible to operate a separate, second section with cooling median, which either is associated with the first section or else is operated in complete isolation.

Entry temperature of the cooling medium into the cooling space is less than 500° C., preferably less than 250° C., and more preferably less than 200° C.

Exit temperature of the cooling medium from the cooling space is less than 500° C., preferably less than 250° C., and more preferably less than 200° C.

The temperature of the inside walls of the flame reactor is less than 500° C., preferably less than 250° C., and more preferably less than 200° C.

Following the reaction in the burner space, the reaction mixture, consisting of particles and process gas, is cooled and the metal oxide particles are separated from the process gas. This is done preferably by way of filters.

A further advantage of cooled flame reactors is that the process gases are precooled in the cooled reactor space. Accordingly the process gas cooling system downstream of the flame reactor can operate more effectively and be made smaller in terms of apparatus.

The metal oxide particles are subsequently purified to remove adsorbed hydrogen chloride gas. This is done preferably in a stream of hot gas, preferred gases are air or nitrogen at temperatures of 250° C.-600° C., preferably 250° C.-500° C., and more preferably 300° C.-450° C.

The invention further provides pyrogenic metal oxides of the general formula II which have been obtained by the process of the invention.

The pyrogenic metal oxides may be oxides from main groups 2 or 3, such as aluminum, silicon, tin, or transition metal oxides such as titanium oxide, zirconium dioxide, iron oxides or others.

Preference is given to silicon dioxide, aluminum oxide, titanium oxide, and zirconium oxide, particular preference to silicon dioxide, and very particular preference to pyrogenic silicon dioxide.

The pyrogenic metal oxides of the invention have a specific surface area of preferably greater than 10 m²/g, more preferably between 30 and 500 m²/g, and with particular preference between 50 and 450 m²/g, measured by the BET method in accordance with DIN EN ISO 9277/DIN 66/22.

The metal oxides of the invention are further characterized in that they preferably have a small fraction of coarse particles.

This means that the polydispersity index (PDI) of the average intensity-weighted particle diameter z-average of the metal oxides of the invention, obtained by means of photon correlation spectroscopy, is less than 0.3, preferably less than 0.25, and more preferably less than 0.2. This additionally means that the metal oxides of the invention have a Mocker sieve residue, measured in accordance with DIN EN ISO 787-18, of less than 0.04%, preferably less than 0.01%, and more preferably less than 0.007%.

The metal oxides of the invention are characterized in particular in that they have a small fraction of difficult-to-disperse particles.

This means that the grindometer value of the metal oxides of the invention in a polydimethylsiloxane having a specific viscosity of 1000 cS is less than 150 μM, preferably less than 120 μm, and more preferably less than 100 μm.

This additionally means that moisture-crosslinking silicone sealants (RTV I compositions) which comprise the metal oxides of the invention exhibit only few, and preferably no, surface defects due to coarse particles or inadequately dispersed particles.

The metal oxide particles produced in accordance with the invention are preferably characterized in particular in that they feature an excellent production consistency with a low range of fluctuation (standard deviation according to standard distribution) in quality-relevant parameters. The standard deviation a is the square root of the variance, calculated according to formula (III).

$$σ = \sqrt{\frac{1}{N - 1} \cdot {\sum }_{i = 1}^{N} {( {x}_{i} - \overline{x} )}^{2}} \qquad ( III )$$

Here, N is the number of individual values, xᵢ one individual value, and x̅ is the average value of all the xᵢ values, with i being in the range from 1 to N.

The metal oxides of the invention are preferably characterized in particular in that they exhibit a high production consistency with a small breadth of variation of extraneous metallic impurities.

This means here, specifically, for the iron content a standard deviation of preferably less than 0.5 ppm, more preferably less than 0.3 ppm, and with particular preference less than 0.2 ppm from the average value over a production period of 30 batches with a batch size of at least 1 tonne.

This means, additionally, for the nickel content a standard deviation of preferably less than 0.5 ppm, more preferably less than 0.3 ppm, and with particular preference less than 0.2 ppm from the average value over a production period of 30 batches with a batch size of at least 1 tonne.

This means, additionally, for the molybdenum content a standard deviation of preferably less than 0.2 ppm, more preferably less than 0.1 ppm, and with particular preference less than 0.05 ppm from the average value over a production period of 30 batches with a batch size of at least 1 tonne.

This means, additionally, for the chromium content a standard deviation of preferably less than 0.25 ppm, more preferably less than 0.1 ppm, and with particular preference less than 0.05 ppm from the average value over a production period of 30 batches with a batch size of at least 1 tonne.

This means, additionally, for the aluminum content a standard deviation of preferably less than 3.0 ppm, more preferably less than 2.0 ppm, and with particular preference less than 1.5 ppm from the average value over a production period of 30 batches with a batch size of at least 1 tonne.

The metal oxides of the invention are further characterized in that the average particle size, measured as the average intensity-weighted particle equivalent diameter z-average by photon correlation spectroscopy, using a Nanosizer ZS from Malvern, in 173° backscatter, over a production period of 30 batches with a batch size of at least 1 tonne, exhibits a standard distribution with a standard deviation of preferably not more than 10% of the average particle size, more preferably of not more than 7.5% of the average particle size, and with particular preference of not more than 5% of the average particle size, and, in one special version, of not more than 1% of the average particle size.

The metal oxides of the invention are further characterized in that the specific surface area of the metal oxide particles, measured as BET surface area in accordance with DIN EN ISO 9277/DIN 66/32, over a production period of 30 batches with a batch size of at least 1 tonne, exhibits a standard distribution having a standard deviation of preferably not more than 10% of the specific BET surface area, preferably of not more than 7.5% of the specific BET surface area, and more preferably not more than 5% of the specific BET surface area.

The coarse fraction or fraction of difficult-to-disperse particles in metal oxides is a key quality-determining parameter particularly in the context of use as a reinforcing filler in elastomers, in the rheology control of paints, varnishes, adhesives, and sealants, and in the field of the chemical-mechanical planarization of surfaces in the semiconductor sector.

Production consistency, i.e., consistent quality of the metal oxide particles, is critical to the successful use of the particles as a reinforcing filler in elastomers, in the rheology control of paints, varnishes, adhesives, and sealants, and in the field of the chemical-mechanical planarization of surfaces in the semiconductor sector.

### EXAMPLES

### Example 1

10.8 kg/h silicon tetrachloride are mixed with 76.3 Nm³/h air and 20.7 Nm³/h hydrogen gas and the mixture is passed into a flame in a flame reactor in a burner nozzle of known construction. An additional 12.0 Nm³/h air are blown into the flame reactor. The walls of the reactor chamber were controlled to 170° C. with water. The cooling water exit temperature was 180° C. Following exit from the flame reactor, the resulting silica/gas mixture is cooled to 120-150° C., and subsequently the silica is separated from the hydrogen chloride-containing gas phase in a filter system. Subsequently, at elevated temperature, residues of hydrogen chloride are removed by addition of air heated via the combustion of natural gas. A fumed silica is obtained whose analytical data are summarized in table 1.

### Example 2

10.8 kg/h silicon tetrachloride are mixed with 63.8 Nm³/h air and 16.9 Nm³/h hydrogen gas and the mixture is passed into a flame in a flame reactor in a burner nozzle of known construction. An additional 20.0 Nm³/h air are blown into the flame reactor. The walls of the reactor chamber were controlled to 170° C. with water. The cooling water exit temperature was 180° C. Following exit from the flame reactor, the resulting silica/gas mixture is cooled to 120-150° C., and subsequently the solid silica is separated from the hydrogen chloride-containing gas phase in a filter system. Subsequently, at elevated temperature, residues of hydrogen chloride are removed by addition of air heated via the combustion of natural gas. A fumed silica is obtained whose analytical data are summarized in table 1.

### Example 3

### Comparative Example, not Inventive

10.8 kg/h silicon tetrachloride are mixed homogeneously in a mixing chamber with 76.3 Nm³/h air and 20.7 Nm³/h hydrogen gas and the mixture is passed in a flame into a flame reactor in a burner nozzle of known construction. An additional 12.0 Nm³/h air are blown into the flame reactor. The walls of the reactor chamber were not actively cooled. As a result of temperature radiation by the uninsulated reactor chamber walls into the surrounding area, a reactor chamber wall temperature of 630° C. came about. Following exit from the flame reactor, the resulting silica/gas mixture is cooled to 120-150° C., and subsequently the solid silica is separated from the hydrogen chloride-containing gas phase in a filter system. Subsequently, at elevated temperature, residues of hydrogen chloride are removed by addition of air heated via the combustion of natural gas. A fumed silica is obtained whose analytical data are summarized in table 1.

### Example 4

In accordance with example 1, 30 independent batches with a minimum batch size of 1 tonne are produced. The production consistency of the analytical data is summarized in table 2.

### Example 5

In accordance with example 2, 30 independent batches with a minimum batch size of 1 tonne are produced. The production consistency of the analytical data is summarized in table 2.

### Example 6

### Comparative Example, not Inventive

In accordance with example 3, 30 independent batches with a minimum batch size of 1 tonne are produced. The production consistency of the analytical data is summarized in table 2.

### Analytical Methods:

Fe, Cr, Ni, and Mo content and their standard deviation a/nm: measurement by means of ICP-MS from the aqueous extract of the digestion of silica with aqueous HF.
Al content and the standard deviation a/nm: measurement by means of ICP-AES from the aqueous extract of the digestion of silica with aqueous HF.
Specific BET surface area and its standard deviation σ/%: measured to DIN EN ISO 9277/DIN 66/32; σ/%=σ/average BET value from 30 batches*100%.
Intensity-weighted hydrodynamic equivalent diameter z-average and its standard deviation σ/% and polydispersity index PDI: measured by means of PCS in 173° backscatter; measurement time: 15 runs with 40 s per run at 25° C.; sample: 0.3 wt. % in an ammoniacal solution with a pH of 10; dispersion for 2.5 min by means of ultrasound probe; σ/%=σ/average z-average from 30 batches*100%.
Sieve residue: measurement by Mocker method (>40 μm) to DIN EN ISO 787-18.
Grindometer value: 2 g of silica are stirred with a spatula into 98 g of a polydimethylsiloxane having a viscosity of 1000 cS and subsequently dispersed in a dissolver with a 40 mm toothed disk at a peripheral speed of 5600 rpm for 5 min. Measurement on a grindometer with measuring range 0-250 μm.

TABLE 1

| | | Sieve | | | Grindometer |
|---|---|---|---|---|---|
| Example | BET/m2/g | residue/% | z-average/nm | PDI | value/μm |
| 1 | 201 | 0.002 | 203 | 0.163 | <75 |
| 2 | 156 | 0.003 | 214 | 0.132 | <75 |
| 3 | 204 | 0.067 | 211 | 0.319 | >150 |

TABLE 2

| Example | σ(Fe)/nm | σ(Cr)/nm | σ(Ni)/nm | σ(Mo)/nm | σ(Al)/nm | σ(BET)/% | σ(z-average)/% |
|---|---|---|---|---|---|---|---|
| 4 | 0.17 | 0.05 | 0.11 | 0.04 | 1.3 | 2.2 | 0.65 |
| 5 | 0.12 | 0.03 | 0.19 | 0.02 | 0.9 | 2.4 | 0.61 |
| 6 | 0.93 | 0.37 | 1.31 | 0.229 | 4.49 | 11.5 | 12.4 |

1.-16. (canceled)

17. A metal oxide production apparatus comprising at least one burner nozzle, a feed apparatus for the reaction materials, a reactor wall, and a reactor-wall cooling system which provides a wall temperature of less than 500° C.

18. The metal oxide production apparatus of claim 17, wherein the cooling system provides a wall temperature of less than 200° C.

19. A process for producing pyrogenic metal oxides, comprising high-temperature hydrolysis of vaporizable halogen metal compounds of the formula I
MhₐR_{b}X_{c} (I)
to metal oxides in the formula II
M_{d}Oₑ (II)
wherein
M is Si, Al, Ti, Zr, Zn, Ce, Hf, or Fe
R is an M-C-bonded, C₁-C₁₅ hydrocarbon radical, preferably a C₁-C₈ hydrocarbon radical and more preferably a C₁-C₃ hydrocarbon radical, or aryl radical, each R being the same or different,
X is a halogen atom or OR radical, R being as defined above,
a is 0, 1, 2, or 3,
b is 0, 1, 2, or 3,
c is 1, 2, 3, or 4,
d is 1 or 2,
e is 1, 2, or 3
with the proviso that the sum a+b+c is
4 for Si, Ti, Zn, Zr, Hf,
3 for Al, Fe,
2 for Zn,
the process taking place in a production apparatus of claim 17 at a reactor wall temperature of less than 500° C.

20. The process for producing pyrogenic metal oxides of claim 19, wherein the process takes place at a reactor wall temperature of less than 200° C.

21. The process for producing pyrogenic metal oxides of claim 19, wherein the pyrogenic metal oxide is pyrogenic silicon dioxide.

22. The process for producing pyrogenic metal oxides of claim 20, wherein the pyrogenic metal oxide is pyrogenic silicon dioxide.

23. A pyrogenic metal oxide having a polydispersity index (PDI) of the average intensity-weighted particle diameter z-average of the metal oxides, obtained by means of photon correlation spectroscopy, of less than 0.3.

24. The pyrogenic metal oxide of claim 23, wherein the polydispersity index (PDI) of the average intensity-weighted particle diameter z-average of the metal oxides, obtained by means of photon correlation spectroscopy, is less than 0.3.

25. The pyrogenic metal oxide of claim 24, wherein the metal oxide is pyrogenic silicon dioxide.

26. The pyrogenic metal oxide of claim 24, wherein the iron content exhibits a standard deviation of less than 0.5 ppm from the average value over a production period of 30 batches with a batch size of at least 1 metric ton.

27. The pyrogenic metal oxide of claim 24, wherein the nickel content exhibits a standard deviation of less than 0.5 ppm from the average value over a production period of 30 batches with a batch size of at least 1 metric ton.

28. The pyrogenic metal oxide of claim 24, wherein the molybdenum content exhibits a standard deviation of less than 0.2 ppm from the average value over a production period of 30 batches with a batch size of at least 1 metric ton.

29. The pyrogenic metal oxide of claim 24, wherein the chromium content exhibits a standard deviation of less than 0.25 ppm from the average value over a production period of 30 batches with a batch size of at least 1 metric ton.

30. The pyrogenic metal oxide of claim 24, wherein the aluminum content exhibits a standard deviation of less than 3.0 ppm from the average value over a production period of 30 batches with a batch size of at least 1 metric ton.

31. The pyrogenic metal oxide of claim 24, wherein the specific surface area of the metal oxide particles, measured as BET surface area in accordance with DIN EN ISO 9277/DIN 66/32, over a production period of 30 batches with a batch size of at least 1 metric ton, exhibits a standard distribution having a standard deviation of not more than 10% of the specific BET surface area.

32. The pyrogenic metal oxide of claim 24, wherein the average particle size, measured as the average intensity-weighted particle equivalent diameter z-average by photon correlation spectroscopy in 173° backscatter, over a production period of 30 batches with a batch size of at least metric 1 ton, exhibits a standard distribution with a standard deviation of more than 10% of the average particle size.

33. The pyrogenic metal oxide of claim 31 which comprises pyrogenic silicon dioxide.

34. The pyrogenic metal oxide of claim 32 which comprises pyrogenic silicon dioxide.
